(19) United States
(12) Patent Application Publication
(10) Pub. No.: US 2024/0291339 A1
(43) Pub. Date: Aug. 29, 2024

(54) ELECTRIC MOTOR OF AN AUXILIARY UNIT OF A MOTOR VEHICLE

(71) Applicant: Brose Fahrzeugteile SE & Co. Kommanditgesellschaft, Würzburg, Würzburg (DE)

(72) Inventors: Alexander Volkamer, Oberscheinfeld (DE); Moritz Obendorfer, Würzburg (DE)

(21) Appl. No.: 18/628,995

(22) Filed: Apr. 8, 2024

Related U.S. Application Data
(63) Continuation of application No. PCT/EP2022/077527, filed on Oct. 4, 2022.

(30) Foreign Application Priority Data
Oct. 8, 2021 (DE) 10 2021 211 368.0

(51) Int. Cl. H02K 3/28; H02K 3/50

(52) U.S. Cl. CPC H02K 3/28; H02K 3/50; H02K 2203/09

(57) ABSTRACT

An electric motor of an ancillary or auxiliary unit of a motor vehicle, in particular an electromechanical brake booster, includes a stator disposed concentrically to a rotor axis. The stator includes a plurality of electric coils wired for a plurality of phases. A one-piece or integral bus bar electrically contacts each phase and protrudes through a passage opening of a bearing shield. The busbars are at least partially encased or surrounded by a common plastic material overmolding or encapsulation. An ancillary or auxiliary unit of a motor vehicle is also provided.

The invention relates to an electric motor of an ancillary unit of a motor vehicle. The invention furthermore relates to an ancillary unit of a motor vehicle.

Motor vehicles such as passenger motor vehicles have a multiplicity of ancillary units which do not directly serve for propelling the motor vehicle. Ancillary units of this type are required for operating the main drive, for example, or serve to provide or enhance the comfort level for the user of the motor vehicle. An ancillary unit of this type is, for example, an electromotive adjustment drive such as an electromotive window regulator. Alternatively, the ancillary unit is an electromotive refrigerant compressor, for example, which is in particular a constituent part of a refrigerant circuit of the motor vehicle.

In another alternative, the electric motor is a constituent part of the brake system of the motor vehicle. The electric motor herein is, for example, a constituent part of an anti-lock brake system, of a traction control system, or of a brake force distributor activated by an electric motor. However, it is also possible for the electric motor to be used in a brake booster. In the latter, an applied pedal force is in particular boosted by means of the electric motor. For example, the brake booster is at least in part of a hydraulic design, and in particular a hydraulic pump is operated and/or potential valves are activated by means of the electric motor.

Alternatively, the brake booster is of an electromechanical design. The electromechanical brake booster herein in most instances comprises an input rod which for activating the brake is moved in a longitudinal direction by means of a foot pedal. The input rod acts on a working piston by means of which a pressure in a brake fluid system is increased. The electric motor acts on the input rod in such a way that an activation of the foot pedal is facilitated. Thus, a force to be applied by a user for activating the brake is reduced. Moreover, by virtue of the electric motor, the brake booster is independent of any actual activation of the foot pedal, and the input rod, particularly by means of the electric motor, can in particular be moved independently of the foot pedal as a function of specified driving situations, this leading to the motor vehicle being decelerated.

In order to keep wear as low as possible, the electric motor is in most instances designed as a brushless DC (BLDC) motor. The electric motor in this instance has a rotor which comprises a plurality of permanent magnets and which is co-rotationally fastened to a rotor shaft. The rotor shaft is mounted so as to be rotatable about a rotor axis by means of one or a plurality of bearings, each bearing being fastened to a respective bearing shield. The stator has a plurality of electric coils which are electrically wired for three phases by means of an interconnection ring mounted on the stator. The individual phase connectors herein are offset by 120° relative to the rotor axis, and a connector which is guided through a corresponding opening of the bearing shield usually electrically contacts these phase connectors.

Electronics for energizing the phases are in most instances disposed on that side of the bearing shield that lies opposite the stator, said electronics comprising a bridge circuit and being provided by means of a circuit board. It is thus necessary to connect each of the connectors to the electronics by means of a respective further conductor. When the electric motor is used in a comparatively harsh environment, it is moreover necessary to provide the openings with a seal so as to avoid the ingress of foreign particles between the rotor and the stator, which may lead to malfunctioning.

The invention is based on the object of specifying a particularly suitable electric motor of an ancillary unit of a motor vehicle, and a particularly suitable ancillary unit of a motor vehicle, whereby robustness is advantageously enhanced and/or production is simplified.

In terms of the electric motor, this object is achieved according to the invention by the features of claim 1, and in terms of the ancillary unit by the features of claim 10. Advantageous refinements and design embodiments are the subject matter of the respective dependent claims.

The electric motor is a constituent part of an ancillary unit. The electric motor is suitable, in particular provided and specified, for this purpose. The ancillary unit is a constituent part of a motor vehicle. In other words, the ancillary unit in the intended state is assembled on further constituent parts of the motor vehicle. The ancillary unit is suitable, in particular provided and specified, for this purpose. The motor vehicle is in particular land-based and preferably designed with a plurality of tracks. It is suitably possible for the motor vehicle herein to be substantially freely placed, for example on a corresponding road surface. For this purpose, the motor vehicle has in particular suitable wheels. In summary, it is preferably possible for the motor vehicle to be positioned on terrain substantially irrespective of other conditions. In other words, the motor vehicle is suitably not rail-bound. The motor vehicle is preferably a passenger motor vehicle or a commercial motor vehicle such as a motor truck or bus.

In the intended use, the ancillary unit does not directly serve for propelling the motor vehicle and thus does not represent a main drive of the motor vehicle. For example, the ancillary unit herein serves for operating the main drive, or for providing functions required for the operation of the motor vehicle, said functions not serving directly for propelling the motor vehicle. Alternatively, a comfort level is enhanced, or comfort functions are provided, by means of the ancillary unit.

The ancillary unit has for example a nominal or maximal output between 100 W and 1000 W, preferably between 300 W and 700 W, and, for example, between 400 W and 500 W. The ancillary unit is, for example, an electromotive adjustment drive such as an electromotive window regulator. Alternatively, the ancillary unit is, for example, an electromotive refrigerant compressor, which is in particular a constituent part of a refrigerant circuit of the motor vehicle. In another alternative, the ancillary unit is an electromotive pump such as a water pump. The electromotive pump is suitably a lubricant pump such as a motor oil pump or a transmission oil pump. A pump wheel which is adapted to the liquid to be pumped is in each case driven by means of the electric motor herein. In another alternative, the electric motor is a constituent part of a fan such as of a radiator fan or of a blower, which thus represent the respective ancillary unit. In one alternative, the ancillary unit is a steering servo, and a steering rod is in particular driven by means of the electric motor, or at least one steering movement of wheels of a steerable design of the motor vehicle is adjusted by means of the electric motor, or the adjustment of said wheels is facilitated by the latter.

In a further alternative the ancillary unit is a braking system or part of the braking system of the vehicle. The electric motor herein is, for example, a constituent part of an anti-lock brake system, of a traction control system, or of a brake force distributor activated by an electric motor. The ancillary unit is particularly preferably a brake booster, wherein a pedal force applied to a brake pedal by a user, also referred to as operator or driver, is in particular boosted by means of the electric motor during operation. For example, the brake booster is at least in part of a hydraulic design, and in particular a hydraulic pump is operated and/or potential valves are activated by means of the electric motor.

For example, the brake booster is at least in part of a hydraulic design, and in particular a hydraulic pump is operated and/or potential valves are activated by means of the electric motor. Particularly preferably however, the brake booster is of an electromechanical design, and the ancillary unit is thus an electromechanical brake booster. A construction of the ancillary unit is consequently simplified.

The electromechanical brake booster expediently comprises an input rod which for activating the brake is moved in a longitudinal direction by means of a foot pedal. The foot pedal herein is, for example, articulated directly on the input rod, or via a rod assembly, for example. However, the foot pedal is at least operatively connected to the input rod. The input rod acts on a working piston. For example, the working piston is fastened directly to the input rod, in particular integrally molded thereon. Alternatively, a further mechanism is disposed therebetween. The working piston is in particular disposed in a pump chamber in which a brake fluid is present during operation. Depending on the direction of movement, the brake fluid is forced out of the pump chamber or suctioned into the latter during a linear movement of the working piston in the pump chamber. Potential brake pistons of brakes of a brake system of the motor vehicle are preferably hydraulically connected to the pump chamber in such a way that the brakes are activated when the brake fluid is forced out of the pump chamber.

The input rod is expediently provided with a thread on the circumference, a drive pinion with internal toothing being placed on said thread. Here, a type of spindle is formed by means of the input rod and the drive pinion. The drive pinion is expediently driven by means of the electric motor, for example directly or preferably by way of a gearbox. When the electric motor is energized, a force is thus introduced into the input rod by the drive pinion, and consequently also onto the working piston.

The electromechanical brake booster preferably comprises a sensor by means of which an activation of the foot pedal acting as the brake pedal is detected during operation. The electric motor is energized as a function thereof. The electromechanical brake booster suitably comprises a control apparatus by means of which the sensor is read and the energization of the electric motor is adjusted. In a refinement, the electric motor is energized by means of the control apparatus irrespective of an actual activation of the foot pedal, preferably as a function of a provided command which is in particular transmitted by way of a potential bus system. The command herein is initiated, for example, by an assistance system of the motor vehicle or of an on-board computer of the motor vehicle. The command herein is in particular initiated as a function of specific driving situations, for example by an emergency brake assistant. Alternatively or in combination therewith, the motor vehicle is designed to be partially or completely autonomous in such a way that travel takes place independently of control by a user. The command herein is in particular initiated by a so-called autopilot.

The electric motor has a rotor axis along which is disposed in particular a rotor shaft, the latter thus being concentric with the rotor axis. The rotor shaft is suitably rotatably mounted by means of one or a plurality of bearings, wherein at least one of the bearings is expediently attached to a bearing shield of the electric motor. If the other bearing is present, the latter is preferably assigned to another bearing shield, the latter being formed by means of a (motor) housing of the electric motor, for example. A rotor is preferably co-rotationally 27 attached to the rotor shaft and thus likewise mounted so as to be rotatable about the rotor axis. The rotor is in particular disposed concentrically with the rotor shaft. The rotor comprises for example a laminated core in which permanent magnets are embedded, or on which permanent magnets are held.

The electric motor furthermore comprises a stator which is disposed concentrically with the rotor axis and circumferentially surrounds the rotor, for example, so that the electric motor is designed as an internal rotor motor. The stator has a plurality of electric coils which are preferably made of an enameled wire, preferably an enameled aluminum wire, or an enameled copper wire. Two of the electric coils are in each case preferably formed by means of a common wire and thus connected by means of a wire portion in such a way that the respective two electric coils are electrically connected in series. In particular, the stator has between six electric coils and twenty electric coils, and suitably twelve electric coils, of this type.

Each of the electric coils, which is also referred to as only a coil, is expediently wound on a respectively assigned stator tooth. The stator teeth are preferably formed by means of a common laminated core. One solenoid is in each case formed by means of the electric coils, or the respective solenoid additionally comprises also at least the respective stator tooth.

The electric coils are wired for a plurality of phases, wherein the same number of electric coils are suitably assigned to each of the (electric) phases. If one of the phases herein is energized during operation, all of the electric coils of this phase are energized. The electric coils of the same phase are in particular electrically connected in parallel or in series. For example, the stator comprises two phases of this type, and the electric motor is thus a two-phase motor, or preferably three phases of this type so that the electric motor is of a three-phase design. The phases per se contact one another so as to form a delta connection or star connection, for example. In this way, the electric motor is in particular designed as a brushless DC (BLDC) motor.

The electric motor furthermore comprises a plurality of integral busbars, whereby each of the phases is in each case assigned one of the busbars that electrically contacts the respective phase. In this way, there are at least as many busbars as there are phases. For example, if the phases are connected to form the delta connection, two of the phases are in each case assigned to one of the busbars, or each busbar is in each case assigned to only a single 11 one of the phases, in particular if the phases are connected to one another so as form a star connection. The busbars are in particular made of a metal, for example aluminum, thus pure aluminum or an aluminum alloy, or copper, thus pure copper or a copper alloy. The busbars are in each case in particular embodied as a stamped and bent part, and in particular stamped from a metal sheet and suitably bent.

The busbars protrude through a passage opening of the bearing shield, in particular of the A-side bearing shield, or of the bearing shield proximal to which electronics that in particular electrically contact the busbars are disposed. The electronics herein expediently comprise a bridge circuit which preferably corresponds to the number of phases. If the electric motor only has two phases, thus is of a two-phase design, the bridge circuit is in particular a B4 circuit, and if the electric motor has three phases, thus is of a three-phase design, the electronics are expediently embodied as a B6 circuit, or at least comprise the latter.

The busbars are at least partially encased by a common plastics material overmolding. The plastic injection overmolding is in particular produced by means of plastic injection-molding and made of a plastics material. The plastics material is, for example, a thermoplastic or thermosetting plastic material. With the exception of the respective ends, or at least those regions in which electrical contacting between the busbars and further constituent parts takes place, the busbars are in particular completely surrounded by means of the plastics material overmolding. The plastics material overmolding is contiguous in such a way that the individual busbars are mutually stabilized by means of the plastics material overmolding. A common component, specifically a connector unit, is in particular formed by means of the busbars and the plastics material overmolding. Consequently, stability is further enhanced and shorting of the busbars with further constituent parts is avoided so that safety is further increased.

By virtue of the common plastics material overmolding it is thus possible to separately produce the connector unit which comprises the busbars and the plastics material overmolding, this simplifying production. Moreover, it is thus possible to assemble the connector unit as a component, which is why production time is shortened and production is simplified. Because the busbars and the plastics material overmolding protrude through the common passage opening of the bearing shield in the process, it is only necessary to seal the latter in order to prevent foreign particles from passing through the bearing shield. Production is consequently simplified, and robustness is also enhanced. Moreover, the busbars are mutually stabilized by means of the plastics material overmolding in such a way that it is prevented that one of the busbars is released from one of the phases even in the event of the electric motor being subjected to shock.

For example, the connectors of the busbars to the phases are mutually offset relative to the rotor axis by a first angle which is in particular more than 90°. Alternatively, the first angle is smaller and between 40° and 90°, for example, and in particular between 55° and 65°, and suitably equals 60°. Connecting to the electric coils, and wiring the electric coils to the phases, is thus simplified. No additional component or any extension of potential wire portions of the electric coils is required on the latter here for contacting the busbars, so that a number of required components is reduced. The passage opening has in particular a length in the tangential direction relative to the rotor axis, said tangential direction corresponding to a second angle which is suitably smaller than 45° or 30°. The size of the passage opening is reduced in this way, which is why establishing a resistance to media, thus sealing is simplified. Moreover, by virtue of the busbars being disposed in the common passage opening, said busbars are at least partially disposed in a specific sector relative to the rotor axis, so that contacting said busbars and the potential electronics is simplified. In particular, no further (electrical) conductors are required for contacting the busbars and the electronics, and the busbars directly contact the potential electronics.

Particularly preferably, the busbars, thus all busbars, have an end region which is disposed parallel to the rotor axis and expediently reaches up to an end of the respective busbar. In particular, the potential electronics are contacted, in particular directly, by the end region, in particular the assigned end region, of each busbar. The end regions are guided through the passage opening in such a way that the passage opening is penetrated by means of the end regions. Only the end regions of the busbar are in particular disposed within the passage opening in the process. Consequently, a required size of the passage opening is reduced. Assembling of the bearing shield and of the connector unit by means of introducing the busbars through the passage opening parallel to the rotor axis is also possible in this way, which is why production is furthermore simplified.

For example, the end regions are mutually disposed in a radial direction relative to the rotor axis, or mutually positioned in an arbitrary manner. Particularly preferably however, the end regions are mutually disposed tangentially relative to the rotor axis. Consequently, attaching a further constituent part to the rotor shaft is in particular not impeded by the end regions, whereby it is nevertheless possible to dispose the busbars so as to be suitably spaced apart from one another in such a way that a connection to the potential electronics is facilitated.

For example, the end regions herein are surrounded by means of a common portion of the plastics material overmolding in such a way that robustness is increased. Particular preferably however, each end region is surrounded by a respective portion of the plastics material overmolding, wherein a void is in particular formed between the portions, or a void is partially formed therebetween. As a result the weight of the electric motor, in particular the connector unit, is reduced. For example, the portions are designed so as to be substantially hollow-cylindrical and thus in particular have a constant thickness. Particularly preferably however, the portions are designed to be conical or pyramidal in such a way that the cross section of said portions perpendicular to the rotor axis continuously decreases. The cross section of each conical portion, in particular of the respective end parallel to the rotor axis herein, has in particular the smallest area on that side that faces away from the stator. Consequently, introducing the busbars encased by the plastics material overmolding through the passage openings from the direction of the stator is facilitated, whereby a spacing from a periphery 11 of the passage opening in the assembled position is reduced by virtue of the enlarged cross section of each of the portions.

In particular, one of the conical portions or, for example, two or all of the conical portions, rest (s) on the periphery of the passage opening, and a force-fit is in particular established therebetween. In other words, the bearing shield is pressed onto the connector unit in such a way that stability is increased, on the one hand. On the other hand, a passage of foreign particles between the plastics material overmolding and the periphery of the passage opening is impossible or at least impeded in such a way that any potential sealing can be designed to be comparatively small in terms of construction and cost-effective.

For example, the conical portions are mutually spaced apart, which is why weight is furthermore reduced. Particularly preferably however, the conical portions are connected to one another by means of a stabilizing rib which is disposed so as to be substantially tangential relative to the rotor axis, for example. The stabilizing rib is suitably leaf-shaped. One stabilizing rib of this type is in each case preferably disposed between neighboring conical portions. Stabilizing rib(s) here is/are preferably located on that side of the bearing shield that faces away from the stator, so that the end regions are held so as to be comparatively stable in relation to one another by means of the stabilizing rib (s). Connecting to the potential electronics is simplified in this way. For example, the conical portions transition into one another on that side of the bearing shield that faces the stator, or are integrally molded on a common further constituent part of the plastics material overmolding.

For example, each conical portion rests directly on the periphery of the passage opening. Particularly preferably however, one compression rib which runs parallel to the rotor axis and is in particular designed in the shape of a ramp is integrally molded on each conical portion. The thickness of the compression rib herein is enlarged in particular on that side of the bearing shield that faces the stator. An introduction into the passage opening from the direction of the stator is facilitated in this way. In the assembled state, the compression ribs rest on the periphery of the passage opening, in particular without play. For example, a force-fit is established between each compression rib and the passage opening, whereby the compression rib is partially elastically and/or plastically deformed, for example. In this way, the conical portions are stabilized by means of the compression ribs on the periphery of the passage opening, which increases robustness. Moreover, any movement of the conical portions, for example micromovements, relative to the passage opening, which may lead to damage to the plastics material overmolding and consequently to electrical shorting, is avoided.

For example, only a single compression rib is assigned to each conical portion. These compression ribs are expediently attached to the radially external side of the respective conical portion in terms of the rotor axis, so that any potential compensation of tolerances takes place there. The radially internal side of each conical portion relative to the rotor axis is preferably of a smooth design and rests in particular in a planar manner on the correspondingly equipped periphery of the passage opening. The position of the busbars is thus determined by means of this side of the passage opening, so that assembling of the potential electronics is simplified. In this way, attention 14 also has to be paid to comparatively minor production tolerances only on this side of the passage opening and/or of the plastics material overmolding, which is why production is simplified.

In particular, each conical portion is assigned a plurality of corresponding compression ribs, wherein one corresponding compression rib is for example in each case disposed on the sides, in a tangential direction relative to the rotor axis, said compression rib thus likewise resting on the periphery of the passage opening. In this way, stabilizing of the busbars in the tangential direction also takes place by means of the compression ribs. One corresponding compression rib is herein preferably integrally molded in the tangential direction on each conical portion on both mutually opposite sides, whereby some of said compression ribs do not rest on the periphery of the passage opening, for example, in particular if said compression ribs point toward another conical portion.

However, an increase in stability of the conical portions is performed by means of the compression ribs in such a way that robustness is increased while weight is not excessively increased. In particular, the compression points, or some of the compression ribs, transition into the potential stabilizing rib.

For example, the electric motor has an interconnection ring by means of which the electric coils are connected to one another. The interconnection ring herein comprises in particular further busbars, and the busbars are soldered or welded to corresponding regions of the further busbars, for example. Preferably however, the electric motor comprises an interconnection element which is disposed between the stator and the bearing shield. The interconnection element is in particular made of plastics material and integral, for example. The interconnection element is expediently placed onto the electric coils of the stator and in particular stabilized by means of the latter, preferably by means of the potential laminated core.

The interconnection element has a number of insertion pockets which are in particular oriented tangentially relative to the rotor axis. The openings of the insertion pockets expediently point in an axial direction which is parallel to the rotor axis. One contact element which is in particular held by means of the respective insertion pocket is inserted into each of the insertion pockets. A form-fit and/or a force-fit is preferably implemented between each contact element and the respective insertion pocket. The contact elements are expediently made of the electrically conducting material, preferably metal.

Each of the contact elements comprises a clamping contact which runs in particular in a direction parallel to the rotor axis, whereby that end that faces away from the stator is expediently opened. One of the busbars is in each case clamped by means of each clamping contact. Consequently, the busbars are stabilized by means of the clamping contacts, and for assembling the busbars, preferably the complete connector unit, it is only necessary to insert the busbars into the clamping contacts and to clamp said busbars in the latter. Consequently, no additional tool or fastening means is required, and contacting all of the busbars is performed in a single operative step, which is why production is simplified. The bearing shield is subsequently suitably placed onto the connector unit and in particular assembled on the stator thereafter.

By virtue of the interconnection element which is expediently made of plastics material, shorting between the contact elements is avoided in the process. The insertion pockets are suitably mutually disposed in a tangential direction relative to the rotor axis, whereby an angle of, for example, 30° is in each case formed between neighboring insertion pockets. Stabilizing of the connector unit by means of the insertion pockets/contact elements takes place in this way so that tilting is avoided. Potential wire portions of the electric coils are expediently guided by means of the interconnection element, in particular the portions by means of which two of the electric coils are in each case connected to one another. Consequently, a number of required components is reduced.

Each contact element particularly preferably electrically contacts a wire portion of one of the electric coils in such a way that the electrical contacting of the phases and the busbars takes place by way of the contact elements. In other words, each contact element serves as an interconnection point between one wire portion of the electric coils and the busbars. In particular, a plurality of electric coils electrically contact in each case the contact elements in such a way that the contact element also serves as an interconnection point for the wire portions of electric coils that are electrically interconnected. Particularly preferably, each contact element herein has an insulation displacement contact in which the wire portions of respective electric coils lie.

Potential enamel is in particular partially released from the wire portion by means of the insulation displacement contacts in such a way that electrical contacting takes place. The insulation displacement contacts preferably run parallel to the rotor axis so that assembling is simplified. The insulation displacement contact herein is preferably opened on that side that faces the stator, and the wire portions lie in a slot of the insertion pocket, said slot likewise running parallel to the rotor axis but being opened on that side that faces away from the stator. In this way, it is possible to place the wire portions into the slots, said wire portions subsequently being fixed therein by means of the insulation displacement contact. Assembling is consequently simplified. Each contact element preferably has two insulation displacement contacts of this type, whereby the respective one wire portion, or the respective plurality of wire portions, is/are held by means of each of the insulation displacement contacts. With the exception of the contact elements and the insertion pockets, there are preferably no further constituent parts present for wiring the electric coils to the phases. Production is simplified in this way.

For assembling, the stator is preferably first disposed within a pot-shaped motor housing, and the interconnection element is subsequently placed onto the stator. The corresponding wire portions of the electric coils are expediently placed into the potential slots thereafter, and fixed therein by means of the insulation displacement contact of the contact elements, the latter being introduced into the insertion pockets for this purpose. Subsequently, the bearing shield is introduced into the motor housing, and/or fastened to the latter, to which end the bearing shield is moved parallel to the rotor axis, and whereby the busbars are guided through the passage opening. In one alternative, the wire portions of the electric coils are first placed into the potential slots and fixed therein by means of the insulation displacement contacts of the contact elements, the latter being introduced into the insertion pockets for this purpose. The positioning of the stator in the motor housing is performed only thereafter. The stator is suitably press-fitted into the motor housing in the process.

The end regions are particularly preferably present if the interconnection element having the insertion pockets is present. For example, the end regions herein are spaced apart from the insertion pockets. Particularly preferably however, all end regions are supported on one of the insertion pockets, thus on one common insertion pocket. The end regions are however at least supported on that clamping element that is assigned to this insertion pocket, said clamping element in this way being press-fitted into the assigned insertion pocket by means of the end regions.

Consequently, the end regions are supported on the insertion pocket by way of this contact element. In summary, the end regions are located in the extension of one of the insertion pockets in a direction parallel to the rotor axis, and the end regions rest on this insertion pocket, in particular by way of the plastics material overmolding. Consequently, the plastics material overmolding per se is placed onto the insertion pocket, in particular onto the shoulders of the insertion pocket. In this way, the end regions are stabilized by means of the insertion pocket, in particular when a further component, for example the potential electronics, is/are placed onto the busbars, said further component being moved parallel to the rotor axis for this purpose. It is consequently avoided that the busbars and/or the plastics material overmolding are/is bent as well as offset, thus avoiding a change in the position of the busbars, in particular relative to the bearing shield. Robustness is thus increased, whereby in particular no additional components are required.

For example, the end regions are disposed in an arbitrary manner relative to the potential insulation displacement contact or relative to the potential clamping contact. Particularly preferably however, one of the end regions is disposed above the clamping contact. That busbar that has these end regions herein is expediently clamped by the clamping contact in such a way that the busbar is formed completely by means of the end region, for example. This busbar herein is preferably designed to be completely rectilinear, which facilitates manufacturing.

Alternatively, or particular preferably in combination therewith, one of the end regions is disposed above the insulation displacement contact, thus in the extension of the latter parallel to the rotor axis. In other words, the projections of this end region and of the insulation displacement contact are superimposed parallel to the rotor axis on a common plane perpendicular to the rotation axis. Consequently, the insulation displacement contact is pressed further into the assigned insertion pocket by means of this end region when the busbar is connected to further 7 constituent parts, so that a connection to the wire portions is improved. Robustness is consequently increased. Alternatively, or in combination therewith, due to plastics material overmolding resting on the periphery of the passage opening, the plastics material overmolding and the busbar are pressed onto this insertion pocket parallel to the rotor axis in such a way that electrical contacting is likewise improved.

The contact element lying in this insertion pocket particularly preferably has two insulation displacement contacts, whereby each of the insulation displacement contacts is in each case assigned one of the end regions. The contact element moreover particularly preferably comprises the clamping contact, and a total of three end regions are in particular supported on this insertion pocket. Robustness at the latter is consequently increased.

For example, all of the insertion pockets are of identical construction, which simplifies production. For example, all of the insertion pockets herein are designed to be planar on the outside, which is why manufacturing is facilitated. Moreover, a space requirement is reduced in this way. Alternatively thereto, reinforcement ribs are integrally molded on all of the insertion pockets and run perpendicularly to the arrangement of the latter, which is why robustness is increased. Particularly preferably however, the reinforcement rib running perpendicularly to the arrangement of the insertion pocket is integrally molded only on that insertion pocket on which the end region/the end regions is/are supported. In this way, the reinforcement rib is present only on that insertion pocket that is subjected to more load, so that robustness is increased, but a space requirement is not excessively increased. The reinforcement rib herein is particularly preferably located below one of the end regions so that a force acting on this busbar is at least partially absorbed by means of the reinforcement rib and thus deformation of the insertion pocket is avoided. Consequently, the reinforcement rib is located in the extension of this end region in a direction parallel to the rotor axis. The reinforcement rib herein is expediently attached/integrally molded so as to point away from the rotor axis in the radial direction in such a way that mounting of the potential rotor shaft is not compromised by the reinforcement rib.

For example, only one corresponding reinforcement rib is integrally molded on the insertion pocket. Particularly preferably, two corresponding reinforcement ribs are integrally molded on the insertion pocket, said reinforcement ribs being preferably mutually offset in a tangential direction. Stability is consequently further increased. The reinforcement ribs herein expediently surround one of the contacts of the contact elements, thus, for example, the insulation displacement contact or the clamping contact, so that the mating part lying in the respective contact is also stabilized by means of the reinforcement rib.

The ancillary unit is a constituent part of a motor vehicle, the latter being, for example, a commercial motor vehicle such as a bus or a motor truck. Particularly preferably, the ancillary unit in the assembled state is a constituent part of a passenger motor vehicle. The ancillary unit herein does not directly serve for propelling the motor vehicle, but for operating a main drive, for example, for providing comfort functions and/or adjusting a direction of movement of the motor vehicle. The ancillary unit is particularly preferably a brake booster which is particularly preferably of an electromechanical design. During operation of the electric motor, a pressure in a brake fluid system is in particular increased by means of the brake booster herein. The brake fluid system herein in particular comprises a pump chamber of the electromechanical brake booster, suitably a compensation chamber and preferably a plurality of brake pistons, wherein at least one brake piston is in particular assigned to each wheel of the motor vehicle. Each wheel is suitably assigned a plurality of brake pistons which are in particular disposed on a brake caliper.

The ancillary unit has at least one electric motor and a component driven by the latter, wherein the driven component comprises in particular a drive pinion or any other further gear wheel which suitably engages with a gear wheel of the electric motor. The electric motor comprises a stator which is disposed concentrically with a rotor axis and has a plurality of electric coils which are wired for a plurality of phases. An integral busbar electrically contacts each phase, said busbars protruding through a passage opening of a bearing shield. The busbars are at least partially encased by a common plastics material overmolding.

The invention furthermore relates to a motor vehicle having an ancillary unit of this type.

The refinements and advantages explained in the context of the electric motor apply in an analogous manner also to the ancillary unit/the motor vehicle and to one another, and vice versa.

An exemplary embodiment of the invention will be explained in more detail hereunder by means of the drawing in which:

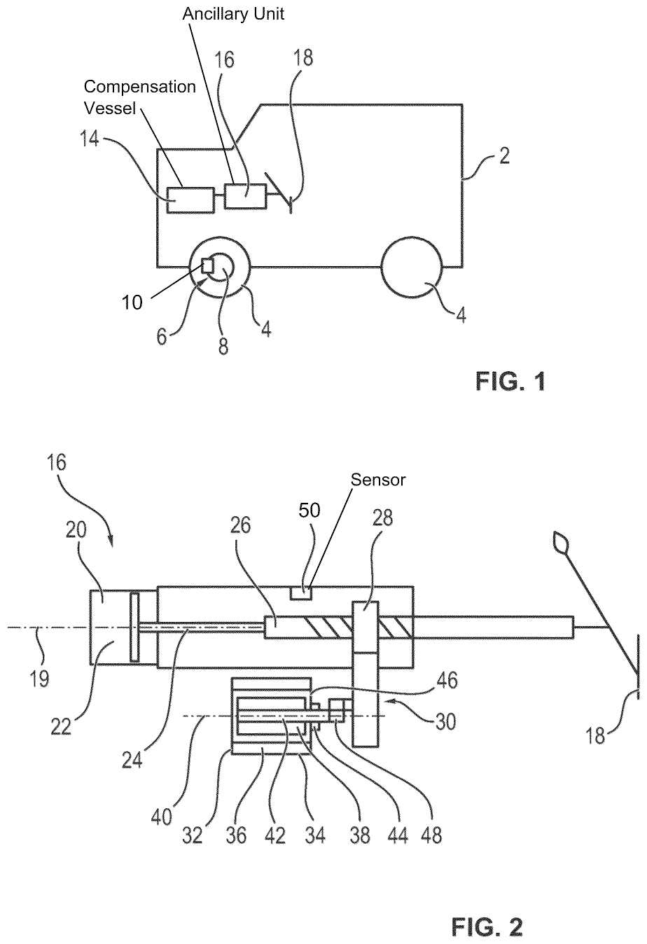

FIG. 1 schematically shows a motor vehicle having an electromechanical brake booster;

FIG. 2 schematically shows the electromechanical brake booster, which has an electric motor, in a sectional illustration;

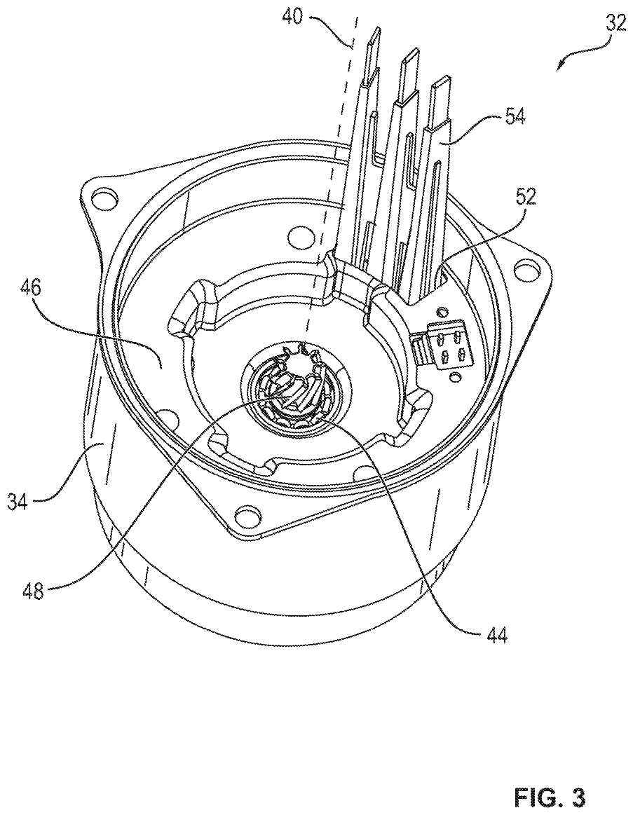

FIG. 3 shows a perspective view of the electric motor having a motor housing;

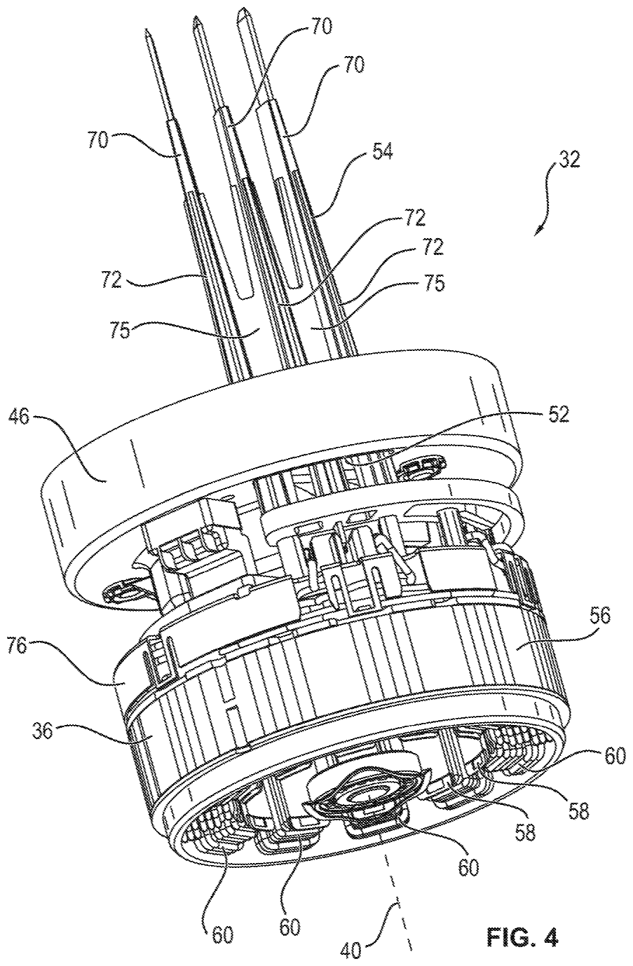

FIG. 4 shows a perspective view of the electric motor having a stator and a bearing shield, without the motor housing;

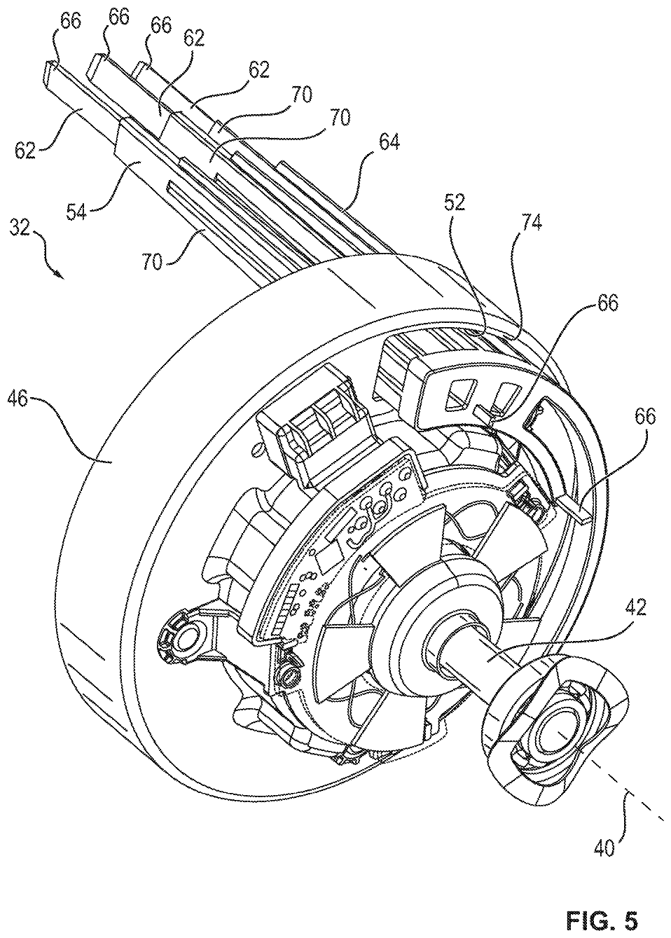

FIG. 5 shows a perspective view of the bearing shield having a passage opening, three busbars having a common plastics material overmolding protruding through the latter;

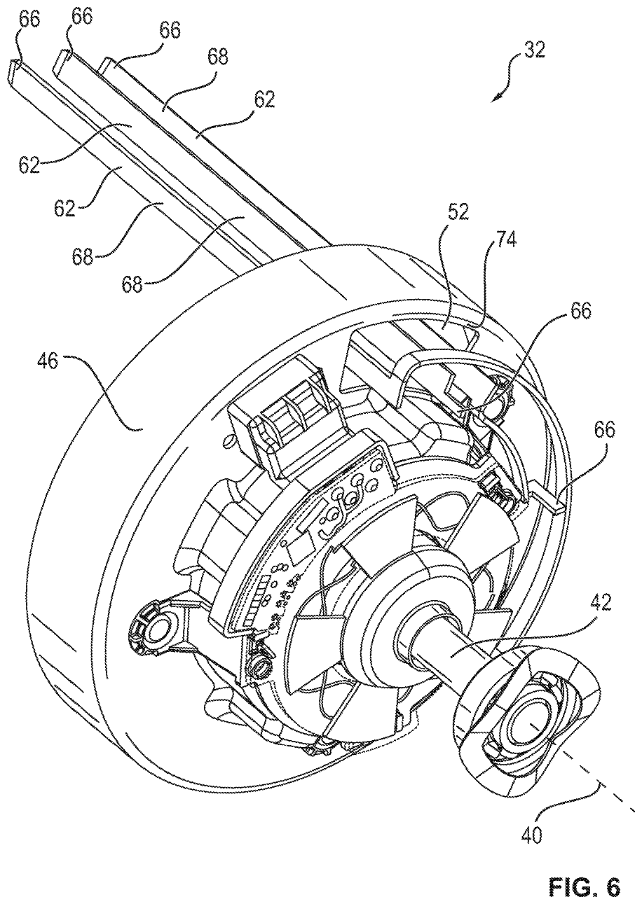

FIG. 6 shows the bearing shield according to FIG. 5 with the plastics material overmolding omitted;

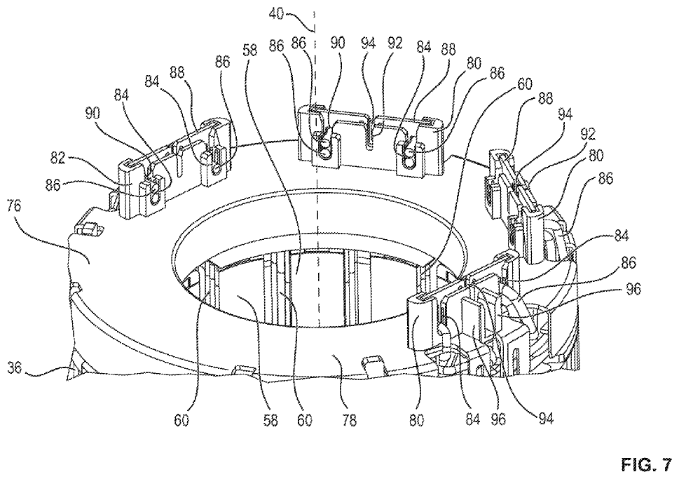

FIG. 7 shows a perspective fragmented view of the stator onto which is placed an interconnection element; and

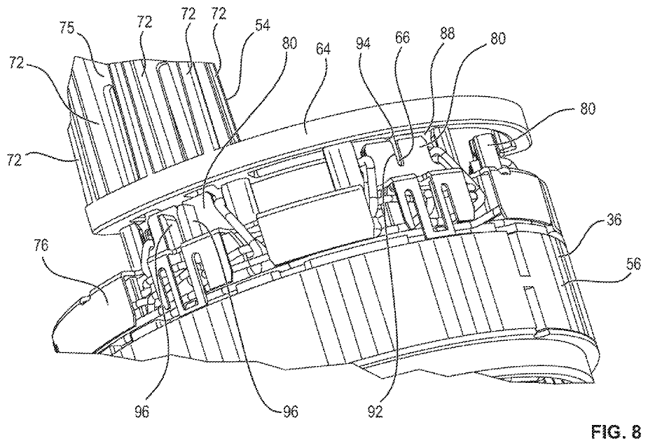

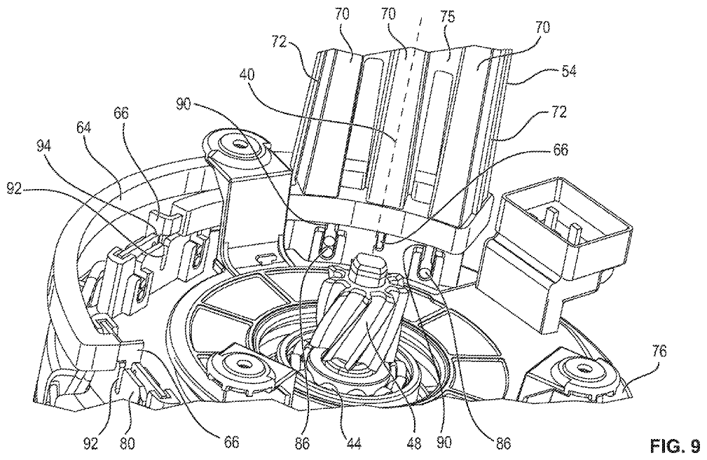

FIGS. 8, 9 show in each case fragmented views of the busbars connected to the interconnection element, from different perspectives.

Mutually equivalent parts are provided with the same reference signs in all figures.

A motor vehicle 2 in the form of a passenger motor vehicle is illustrated in a schematically simplified manner in FIG. 1. The motor vehicle 2 has a plurality of wheels 4 by means of which contact with a road surface, not illustrated in more detail, takes place. Some of the wheels 4 are driven by means of a main drive, not shown. For deceleration, the motor vehicle 2 has a plurality of brakes 6 of which only one is illustrated. Each of the brakes 6 comprises a brake disk 8 which is co-rotationally connected to the respectively assigned wheel 4. A brake caliper 10 of the brake 6, which has a plurality of brake pistons not illustrated in more detail, is fixedly held on the bodywork.

The brake pistons are a constituent part of a brake fluid system 12 which has a compensation vessel 14 that is fluidically coupled to the brake pistons. Furthermore, an ancillary unit 16 in the form of an electromechanical brake booster is coupled to the compensation vessel 14. This brake booster is activated by means of a foot pedal 18, specifically a brake pedal. The brake fluid system 12 is filled with a brake fluid, and, when the foot pedal 18 is activated, a pressure in the brake fluid system 12 is increased by means of the electrical ancillary unit 16, thus the electromechanical brake booster, in such a way that the brake pistons are activated by way of the compensation vessel 14. Consequently, brake pads which are fastened to the brake caliper 10 are pressed against the assigned brake disk 8 in such a way that the motor vehicle 2 is decelerated.

In FIG. 2, the ancillary unit 16, thus the electromechanical brake booster, is illustrated in a sectional illustration along a longitudinal axis 19. This ancillary unit 16 has a pump chamber 20 within which is disposed a working piston 22, the latter being guided along the longitudinal axis 19 by means of the lateral wall of the pump chamber 20. The working piston 22 reaches up to the internal walls of the pump chamber 20 in such a way that the latter is divided into two parts by means of the working piston 22. One of the parts is fluidically connected to the compensation vessel 14 by way of an outlet, not illustrated in more detail, and is completely filled with the brake fluid. In this way, the quantity of the brake fluid disposed in the pump chamber 20 is varied when the working piston 22 moves in the pump chamber 20.

The working piston 22 is fastened to an input rod 26 by way of a connecting rod 24 which is disposed parallel to the longitudinal axis 19, said input rod 26 likewise extending along the longitudinal axis 19 and being mounted so as to be displaceable along the longitudinal axis 19 by means of a mounting, not illustrated in more detail. However, the input rod 26 herein is co-rotationally mounted in such a way that rotation of the input rod 26 is avoided. The input rod 26 is supported on the foot pedal 18 by means of a mechanism on the end lying opposite the connecting rod 24.

When the foot pedal 18 is activated, the input rod 26 and consequently also the connecting rod 24 are moved along the longitudinal axis 19 in such a way that the working piston 22 is also moved. Consequently, the brake fluid is forced out of the pump chamber 20. Furthermore, the ancillary unit 16 has a spring which is not illustrated in more detail and by means of which the input rod 26, and therefore also the connecting rod 24, and consequently also the working piston 22, are impinged. Due to the spring force, the working piston 22 is moved out of the pump chamber 22 as far as possible in such a way that a volume of brake fluid received by the pump chamber 20 is at the maximum.

The input rod 26 has an external toothing, and placed thereon is a drive pinion 28 which in turn has an internal toothing. The input rod 26 and the drive pinion 28 are thus designed in the manner of a spindle. Additionally, the drive pinion 28 has an external toothing and engages with a gearbox 30. The gearbox 30 is driven by means of an electric motor 32 which comprises a pot-shaped motor housing 34 within which is disposed a hollow-cylindrical stator 36. A likewise hollow-cylindrical rotor 38 is disposed concentrically with a rotor axis 40 within the stator 36 and is co-rotationally fastened to a rotor shaft 42 running concentrically with the rotor axis 40. Consequently, the rotor shaft 42 is disposed along the rotor axis 40. The rotor shaft 42 is mounted so as to be rotatable about the rotor axis 40 by means of a further bearing which is not illustrated in more detail and is fastened to the motor housing 34 and lies in the latter, and by means of a bearing 44 which is held on a bearing shield 46 which closes off the motor housing 34.

The rotor 38 comprises a laminated core which is not illustrated in more detail and on which are held permanent magnets, likewise not illustrated in more detail, that interact with solenoids of the stator 36 during operation, so that the rotor 38 and therefore also the rotor shaft 42 are rotated about the rotor axis 40. Consequently, the electric motor 32 is designed as a brushless DC (BLDC) motor. A gear wheel 48 which engages with the gearbox 30 is co-rotationally fastened to the end side on the rotor shaft 42. In this way, a transmission of force from the rotor shaft 42 to the gearbox 30 takes place via the gear wheel 48 which meshes with a corresponding gear wheel of the gearbox 30.

The ancillary unit 16 furthermore comprises a sensor 50 by means of which an activation of the foot pedal 18, specifically an offset of the input rod 26 along the longitudinal axis 19, is detected. The electric motor 32 is energized as soon as this has been detected, so that the drive pinion 28 is rotated by way of the gearbox 30. By virtue of the interlocking action with the input rod 26, an additional force is applied to the input rod 26 along the longitudinal axis 19 in this way, so that the activation of the foot pedal 18 is assisted. Owing to the force exerted by means of the drive pinion 28 and the activation of the foot pedal 18, the working piston 22 is moved in the pump chamber 20, and a driver of the motor vehicle 2 is thus assisted during braking. In summary, the force to be applied for braking by the driver is reduced, which enhances the level of comfort. It is also possible for the ancillary unit 16, thus the electromotive brake booster, to be activated in a manner completely independent of the activation of the foot pedal 18. Consequently, braking of the motor vehicle 2 is performed independently of the activation of the foot pedal 18, for example in the context of emergency braking, or during an automatic/autonomous operation of the motor vehicle 2.

The electric motor 32, which comprises the pot-shaped motor housing 34, is illustrated in a perspective view in FIG. 3. The electric motor 32 is shown from a dissimilar perspective in FIG. 4, whereby the motor housing 34 has been omitted. The motor housing 34 is closed off by means of the bearing shield 46 on which the bearing 44 is held. The bearing shield 46 is likewise made of metal and has a 7 passage opening 52 through which is guided a connector unit 54 by means of which the passage opening 52 is completely or at least partially closed off. The bearing shield 46 is partially recessed into the motor housing 34 in such a way that a protrusion for electronics, not illustrated in more detail, is provided, said electronics in the assembled state electrically contacting the connector unit 54. The electronics herein have a bridge circuit, specifically a B6 circuit.

The stator 36 is disposed concentrically with the rotor axis 40, which is also referred to as motor axis or rotation axis, and has a laminated core 56 which in the assembled state is integrally molded on the circumference on the motor housing 54. A total of twelve stator teeth 58, which point toward the rotor axis 40 and are in each case wound with an electric coil 60 made of enameled copper wire, are formed by means of the laminated core 56. Two of the electric coils 60 herein are in each case wound from a common wire and thus electrically connected to one another.

The electric motor 32 is in each case illustrated from the same perspective in FIGS. 5 and 6, whereby the stator 36 and the rotor 38 are additionally not illustrated. The connector unit 54 protrudes through the bearing shield 46, the latter having the passage opening 52. The connector unit 54 is formed by means of three integral busbars 62 which are designed as a stamped and bent part and made of copper. The three busbars 62 are surrounded by means of a common plastics material overmolding 64 which is not illustrated in FIG. 6. The ends 66 of the busbars 62 herein are free from the plastics material overmolding 64, so that an electrical connection thereto is possible. In contrast, the other regions of the busbars 62 are surrounded by the plastics material overmolding 64. In summary, the integral busbars 62 which are at least partially encased by the common plastics material overmolding 64 thus protrude through the passage opening 52.

The busbars 62 have in each case an end region 68 which is disposed parallel to the rotor axis 40 and as the only part of the respective busbars 62 is guided through the passage opening 52, said busbars 62 being mutually disposed in the tangential direction relative to the rotor axis 40 in such a way that the end regions 68 are mutually offset in the tangential direction. On that side of the bearing shield 46 that faces away from the stator 36, the end regions 68 terminate in each case in one of the ends 66 which are disposed on the same height level along the rotor axis 40. In other words, the end regions 68 transition in each case into one of the ends 66 of the busbar 62. The end regions 68 are mutually offset by an angle of at most 40° relative to the rotor axis 40. The remaining ends 66 of the busbars 62 are located on that side that faces the stator 36 and are offset by an angle of substantially 100° relative to the rotor axis 40, for which purpose the busbars 62 have suitable further portions that are of an arcuate design. The further portions herein are disposed in a plane perpendicular to the rotor axis 40 in such a way that the plastics material overmolding 64 is also of a substantially planar design in this region and terminates in a plane perpendicular to the rotor axis 40. In this way, only the remaining ends 66 of the busbars 62 protrude beyond said plane.

Each of the end regions 68 is surrounded by a conical portion 70 of the plastics material overmolding 64, whereby the area of the cross section thereof, which is in each case rectangular, perpendicular to the rotor axis 40 continuously decreases as the spacing from the stator 36 increases. Three compression ribs 72 which run parallel to the rotor axis are in each case integrally molded on each of the conical portions 70. The compression ribs 72 are designed in the shape of a ramp, whereby the thickness of the compression ribs 72 is enlarged proximal to the stator 36. The compression ribs 72 are integrally molded on the two tangential sides and the radially outer side, in each case relative to the rotor axis 40, on each of the conical portions 70 in such a way that each conical portion 70 is stabilized by means of the compression ribs 72. In contrast, the conical portions 70 are designed to be smooth on the radially inner side.

In the assembled state, the conical portions 70 and thus the end regions 68 rest on the periphery 74 of the passage opening 52 by way of at least one of the compression ribs 72. The end regions 68 herein that are disposed outside in the tangential region rest in each case on the periphery 74 by way of two of the compression ribs 72, whereas the central of the three end region 68 rests on the periphery 74 only by way of one of the compression ribs 72.

The mutually facing compression ribs 72 of neighboring conical portions 70 are extended in length in portions on that side of the bearing shield 36 that lies opposite the stator 36, so that two leaf-shaped stabilizing ribs 75 by means of which the conical portions 70 are thus connected to one another are formed. With the exception of the stabilizing ribs 75, the conical portions 70 are mutually spaced apart, so that a weight of the connector unit 54 is reduced.

Disposed between the stator 36 and the bearing shield 46 is an interconnection element 76 which is integrally produced from plastics material, and is shown in fragments in FIG. 7, and is placed onto the stator 36, specifically one of the end sides thereof. The interconnection element 76 has an annular body 78 by means of which the stator 36 is partially encompassed. Three insertion pockets 80, and one further insertion pocket 82, which run in each case tangentially, are integrally molded on that side on the body 78 that faces away from the stator 36, whereby the opening of each of the insertion pockets 80, 82 points in a direction parallel to the rotor axis 40.

Each of the insertion pockets 80, and the further insertion pocket 82, have two slots 84 which run parallel to the rotor axis 40 and are likewise opened on that side that lies opposite the stator 36, at least one wire portion 86 of different electric coils 60 being in each case disposed within said slots 84, said wire portions 86 thus being electrically connected to one another. A contact element 88 stamped from metal is in each case inserted within the insertion pocket 80 and the further insertion pocket 82, said contact elements 88 thus being in each case of a flat design. The contact elements 88 herein are held in a form-fitting and force-fitting manner in the respectively assigned insertion pocket 80, 82.

The contact elements 88 have in each case two insulation displacement contacts 90 which likewise run parallel to the rotor axis 40 but are opened on that side that faces the stator 36. One of the insulation displacement contacts 90 herein is in each case co-aligned with one of the slots 84 in such a way that one or two of the wire portions 86 lies/lie in each of the insertion displacement contacts 90. Consequently, three or four of the wire portions 86 are electrically connected to one another by means of each of the contact elements 88 in such a way that the contact elements 88 serve as an interconnection point for the wire portions 86. By virtue of the arrangement of the clamping contacts 90 and of the slots 84, it is possible to cancel the electrical contact between the wire portions 86 by means of only removing the respective contact element 88 from the insertion pocket 80, or from the further insertion pockets 32, respectively.

Furthermore, the electric coils 90 are wired for three phases by means of the contact element 88, wherein each of the phases is in each case assigned four of the electric coils 60. Moreover, the phases in the example illustrated are wired so as to form a delta connection.

Furthermore, each of the insertion pockets 80 has a further slot 92 which is disposed between the two slots 84, and runs parallel thereto, and is co-aligned with a clamping contact 94 of the respectively assigned contact element 88. Each clamping contact 94 herein is opened on that side that faces away from the stator 36 in such a way that each clamping contact 94 is accessible even when a contact element 88 is inserted in the respective insertion pocket 80. The further insertion pocket 82, and the contact element 88 inserted therein, also have the further slot 92, or the clamping contact 94, respectively.

In the assembled state, the connector unit 54 is held on the interconnection element 76, as is illustrated in FIGS. 8 and 9. For this purpose, those ends 66 of each busbar 62 that face the stator 36 are in each case introduced into the clamping contact 94 of the contact elements 88 inserted into the insertion pockets 80, and clamped therein. Stabilizing of the respectively assigned end 66 herein is performed by means of the respective further slot 92.

In summary, one of the busbars 62 is in each case clamped by means of each clamping contact 94, and each phase electrically contacts in each case at least one of the busbars 62. Because the phases are wired so as to form a delta connection, each of the contact elements 88 inserted into the insertion pockets 80 electrically contacts in each case two of the phases, so that two of the phases are also 18 electrically contacted by each of the busbars 62. Each of the phases herein is in each case also electrically contacted by two different busbars 62. The clamping contact 94 of the contact element 88, which is inserted into the further insertion pocket 82, does not electrically contact any of the busbars 62, so that this contact element 88 serves only for interconnecting the electric coils 60.

All three end regions 68 are supported on one of the insertion pockets 80, specifically on an outer insertion pocket 80 in the tangential direction, by way of the plastics material overmolding 64. The further insertion pocket 82 adjoins the outer insertion pocket 80 that lies opposite in the tangential direction. The further slot 92 of the insertion pocket 80, on which the end regions 68 are supported, is in the tangential direction relative to the rotor axis 40 surrounded by two reinforcement ribs 96 which run perpendicularly to the arrangement of this insertion pocket 80 and are integrally molded on this insertion pocket 80, and are offset from the latter away from the rotor axis 40. In contrast, no reinforcement ribs are integrally molded on the remaining insertion pockets 80 and the further insertion pocket 82.

One of the end regions 68 is disposed above the clamping contact 94 of the contact element 88 inserted into this insertion pocket 80. The busbar 62 which has this end region 68 is formed only by means of the end region 68 and the two ends 66, and is consequently of a rectilinear or flat design. The remaining end regions 68 are disposed above the two insulation displacement contacts 90 of the contact element 88 inserted into this insertion pocket 80, whereby each of the insulation displacement contacts 90 is in each case assigned one of the end regions 68. The busbars 62 having these end regions 68 herein are electrically isolated from this contact element 88 by virtue of the plastics material overmolding 54.

When assembling the electronics on those ends 66 of the busbars 62 that face away from the stator 36, the contact element 88, which is assigned to the insertion pocket 80 on which the end regions 68 are supported, is press-fitted into the insertion pocket 80, which improves electrical contacting. Moreover, any uncontrolled movement of the busbars 62 is avoided by means of the insertion pocket 80, so that assembling of the electronics is facilitated. In this way, damage to the busbars, specifically bending or offsetting of the end regions 68, is prevented. The insertion pockets 80 are not damaged by virtue of the reinforcement rib 96, even when comparatively high forces prevail.

The invention is not limited to the exemplary embodiment described above. Instead, other variants of the invention may also be derived therefrom by a person skilled in the art without departing from the subject matter of the invention. All of the individual features described in connection with the individual exemplary embodiments are furthermore in particular also able to be combined with one another in other ways without departing from the subject matter of the invention.

### LIST OF REFERENCE SIGNS

2 Motor vehicle
4 Wheel
6 Brake
8 Brake disk
10 Brake caliper
12 Brake fluid system
14 Compensation vessel
16 Ancillary unit
18 Foot pedal
19 Longitudinal axis
20 Pump chamber
22 Working piston
24 Connecting rod
26 Input rod
28 Drive pinion
30 Gearbox
32 Electric motor
34 Motor housing
36 Stator
38 Rotor
40 Rotor axis
42 Rotor shaft
44 Bearing
46 Bearing shield
50 Sensor
52 Passage opening
54 Connector unit
56 Laminated core
58 Stator tooth
60 Electric coil
62 Busbar
64 Plastics material overmolding
66 Ende
68 End region
70 Conical portion
72 Compression rib
74 Periphery
75 Stabilizing rib
76 Interconnection element
78 Body
80 Insertion pocket
82 Further insertion pocket
84 Slot
86 Wire portion
88 Contact element
90 Insulation displacement contact
92 Further slot
94 Clamping contact
96 Reinforcement rib

1-10. (canceled)

11. An electric motor of an ancillary unit or electromechanical brake booster of a motor vehicle, the electric motor comprising:
a stator disposed concentrically with a rotor axis, said stator having a plurality of electric coils wired for a plurality of phases;
a bearing shield having a passage opening;
a plurality of one-piece busbars each electrically contacting a respective one of the plurality of phase, said plurality of one-piece busbars protruding through said passage opening; and
a plastic material overmolding at least partially encasing said plurality of one-piece busbars together.

12. The electric motor according to claim 11, wherein said plurality of one-piece busbars each have one end region disposed parallel to said rotor axis, said end regions are guided through said passage opening, said end regions are mutually disposed tangentially relative to said rotor axis, and each of said end regions is surrounded by a respective conical portion of said plastic material overmolding.

13. The electric motor according to claim 12, wherein said conical portions (70) are connected to one another by a stabilizing rib.

14. The electric motor according to claim 12, which further comprises compression ribs each formed on a respective one of said conical portions, said compression ribs running parallel to said rotor axis and resting on a periphery of said passage opening.

15. The electric motor according to claim 11, which further comprises an interconnection element disposed between said stator and said bearing shield, said interconnection element including a plurality of insertion pockets, said insertion pockets each having a respective contact element inserted therein, and each of said contact elements having a clamping contact clamping a respective one of said plurality of one-piece busbars.

16. The electric motor according to claim 15, wherein said electric coils are electrically wired to one another and have wire portions, and each of said contact elements has an insulation displacement contact acting as an interconnection point for a respective one of said wire portions.

17. The electric motor according to claim 15, wherein said plurality of one-piece busbars each have one end region disposed parallel to said rotor axis, end regions are guided through said passage opening, and all of said end regions are supported on one of said insertion pockets.

18. The electric motor according to claim 17, wherein one of said end regions is disposed above said insulation displacement contact or said clamping contact.

19. The electric motor according to claim 17, which further comprises a reinforcement rib formed on said insertion pocket, said reinforcement rib being perpendicular to said insertion pocket.

20. An ancillary unit or electromechanical brake booster of a motor vehicle, the ancillary unit or electromechanical brake booster, comprising an electric motor according to claim 11.
